(19) United States
(12) Patent Application Publication
(10) Pub. No.: US 2025/0095895 A1
(43) Pub. Date: Mar. 20, 2025

(54) Multipole Magnet Device

(71) Applicant: Jonathan Winnie, Rolling Meadows, IL (US)

(72) Inventor: Jonathan Winnie, Rolling Meadows, IL (US)

(21) Appl. No.: 18/372,460

(22) Filed: Sep. 25, 2023

Related U.S. Application Data
(60) Provisional application No. 63/539,347, filed on Sep. 20, 2023.

(51) Int. Cl. H01F 7/02

(52) U.S. Cl. CPC H01F 7/0252

(57) ABSTRACT

The invention is a multipole disc magnet combined with a metal washer to provide increased load-bearing strength.

### CROSS REFERENCE TO RELATED APPLICATIONS

This application claims priority to U.S. provisional application 63/539,347, filed on Sep. 20, 2023.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

### Field of the Invention

The invention relates to a multipole magnet device for increased load-bearing strength.

### Background of the Invention

Magnetic attachments have long been known as a means of clipping or supporting items to a metal structure. In particular, pot magnets, disc magnets, square magnets and other configurations have been integrated in clip, hook, hanger or similar configurations for hanging or securing objects to a metal surface or base. Such magnetic clip devices are often used for storage in kitchens, utility rooms and garages and, when large and strong enough, can be used to store quite heavy items.

The poles of multiple magnets, used in combination, will act together to enhance the strength of a magnetic field. In one example, stacked magnets are known to increase the pull force against a metal surface, although that pull force has a single point of contact, and thus is more susceptible to downward pulling at an angle. When carefully designed, the use of multiple points of polarity in close proximity can result in a magnetic pull force that mimics a larger individual magnet, thus increasing the weight that can be supported when applied directly away from the metal surface or at a sideways angle.

What is needed is a single physical magnetic device with multiple points of polarity spread throughout such device, such that the pull force of a larger magnet can be mimicked with a smaller footprint.

### BRIEF SUMMARY

In a preferred embodiment, A magnetic device for hanging objects from a metal surface, comprising a disc magnet comprising a plurality of poles in a grid pattern and a metal washer adhered to a surface of the disc magnet.

In another preferred embodiment, the magnetic device as described herein, wherein the disc magnet is program charged to create alternating charges.

In another preferred embodiment, the magnetic device as described herein, comprising nine poles.

In another preferred embodiment, the magnetic device as described herein, wherein the nine poles are arranged in a three-by-three grid with approximately 0.75″ between the center of each adjacent pole.

In another preferred embodiment, the magnetic device as described herein, wherein the nine poles exert a north polarity and the area between the poles exerts a south polarity.

In another preferred embodiment, the magnetic device as described herein, wherein the disc magnet is coated with layers of nickel, copper and epoxy.

In another preferred embodiment, the magnetic device as described herein, wherein a combined depth of the disc magnet and metal washer is ⅜″ and a diameter of the disc magnet is 2″.

In another preferred embodiment, the magnetic device as described herein, wherein a diameter of the metal washer is the same or larger than a diameter of the disc magnet.

### BRIEF DESCRIPTION OF THE DRAWINGS

FIG. 1 is a line drawing evidencing the magnetic fields emanating from the inventive disc magnet.

FIG. 2 is a line drawing evidencing the inventive disc magnet comprising nine poles in a grid pattern.

FIG. 3 is a line drawing evidencing the inventive disc magnet with a metal washer comprising a threaded center hole.

### DETAILED DESCRIPTION OF THE INVENTION

The pull force exerted by multiple magnets in concert will increase when the magnets are placed side-by-side and within a certain distance, whether the poles of the magnets are facing the same direction vis-à-vis the metal surface or the poles are facing opposite directions. Such side-by-side positioning can offset the loss of pull strength at a sideways angle experienced when stacking magnets due to the limited size of the magnets' point of attachment.

However, when two or more magnets are placed next to one another on a metal surface, the magnets will interfere with one another's magnetic field and thus the increase in pull force versus a single magnet will be less than double. For example, a single block magnet with dimensions of ½″×½″×⅛″ attached to a steel plate will exert 7.34 lb of pull force. Two of such magnets placed directly adjacent to one another with the same polar direction on the steel plate will affect one another's magnetic fields, and thus will result in a pull force of only 10.34 lb instead of the 14.68 lb that would be expected of a single magnet of double size and strength.

In contrast, when the two magnets are attached to the metal plate at a distance larger than the magnets' own magnetic fields, they will exert the full combined pull force of 14.68 lb. However, that requires the use of multiple physical magnets and larger surface area. These drawbacks increase when one attempts to combine more than two magnets to increase pull force.

Thus, when attempting to maximize the pull force of an individual magnetic device, especially at a sideways angle, while also limiting the amount of metallic surface area used to form a connection, it becomes necessary to use multiple magnets within such limited surface area. Through the combination of multiple magnetic fields within such area, despite interference between different points of polarity, it becomes possible to exert the pull force of a much larger single magnet within a limited surface area. Such a combination allows for the storage of heavier items in smaller areas, thus maximizing the use of space.

The invention is a multipole magnetic device comprising a multipole charged disc magnet in which each of a plurality of poles exerts a north polarity, with the remaining area between the poles exerting a south polarity. In a preferred embodiment, the disc comprises nine poles. This design accomplishes the dual aims of increasing the strength of the magnet and limiting its surface area.

The poles are created by program charging the magnet on a tray with an electrical charge. The inventive disc magnet operates by amplifying the north and south attraction at the surface. The alternating polarities at the surface amplify the magnetic flux exerted by the disc magnet at its surface, which narrows the comprehensive magnetic field emanating from the surface. The effect of the nine north poles with a surrounding south pole is a compacted magnetic field exerting an amplified pull force across the full face of the magnet.

In a preferred embodiment, the disc magnet will be coated in layers of nickel, copper and finally a layer of epoxy or similar material to combat corrosion and wear and tear.

The addition of a metal washer comprising a threaded hole for attachment of a hook or similar part to the top of the inventive magnet not only provides a means for attaching the object(s) to be suspended, but also has the effect of further amplifying the magnetic field produced by the magnet in the direction opposite the washer and towards the metal object to which the magnet will attach. In a preferred embodiment, the metal washer is a disc with the same or a larger diameter as the disc magnet and is adhered to the disc magnet's surface with epoxy or a similar adhesive material. In one embodiment, the combination disc magnet and metal washer combination is overmolded with plastic.

Testing was done with various numbers of poles, including 4, 16, 32, etc. The testing indicated that the best hold, meaning the best combination of spacing between poles with minimal magnetic was a 9-pole charged magnet. After charging, a disc magnet 2″ in diameter and only ⅛″ in depth, with a ¼″ depth metal washer adhered to the top, was able to exert up to 400 lb of pull force, the equivalent of a 2″ by 2″ rare earth disc magnet or a 24″ by 48″ ceramic block magnet.

By exerting the same pull force as a disc magnet sixteen times its mass, the inventive nine-pole disc magnet not only saves surface area but also materials and shipping cost. The inventive disc magnet is also significantly less expensive than a rare earth magnet of corresponding strength.

In a preferred embodiment, the inventive disc magnet is disc-shaped, with a diameter between ½″ and 6″ and a depth between 1/64″ and ½″. In a more preferred embodiment, the diameter is between 1″ and 3″ and the depth is between ¼″ and ½″. The preferred ratio between depth and diameter is a range between 1:12 and 1:32. A more preferred ratio is 1:16. The preferred distance between poles within the disc magnet is 0.125″ to 1.25″ with a more preferred distance of approximately 0.75″.

In a further preferred embodiment, the inventive magnetic device will comprise metal washer adhered to the disc magnet's top surface, such washer comprising a threaded center hole for attachment of a hook or other means of hanging an object, such metal washer preferably between 1/32″ and ¾″ in diameter, with a more preferred diameter of ¼″.

The inventive disc magnet is especially useful when attaching items to a thin metal surface, for which the use of screws or similar fasteners may be unwieldy or impossible. For example, the inventive magnets can be used inside of vehicles, one electrical hardware or metal cabinetry to store tools.

### DETAILED DESCRIPTION OF THE DRAWINGS

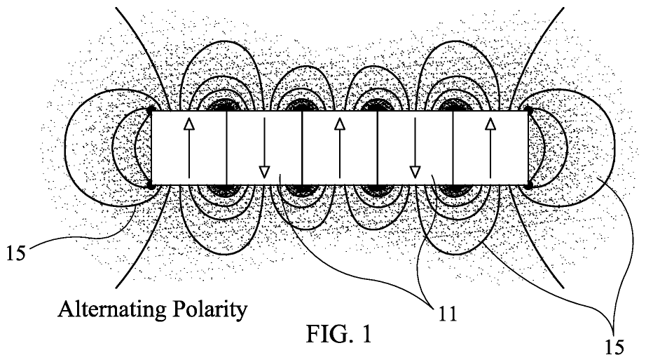

FIG. 1 shows a cross-section of the inventive disc magnet 14 with alternating poles 11 and area between the poles 12, resulting in tightened and thereby strengthened magnetic fields 16.

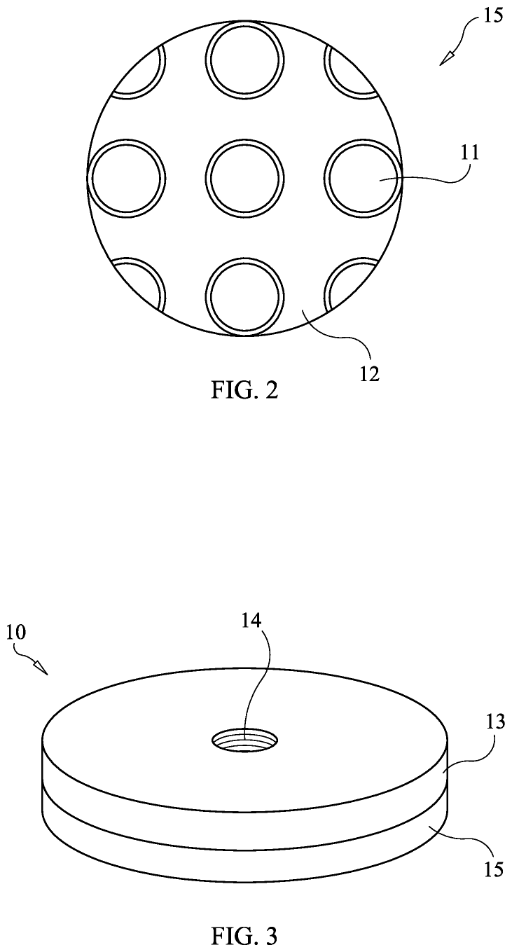

FIG. 2 shows the pattern consisting of nine poles 11 and an area between the poles 12 within the inventive disc magnet 10. In this iteration, the poles 11 exert a north polarity and the area between the poles 12 exerts an alternate south polarity.

FIG. 2 shows the inventive disc magnet comprising a central, threaded hole 13 point of attachment.

### INVENTION COMPONENTS

10 magnetic device
11 pole (north)
12 area between poles (south)
13 metal washer
14 threaded hole
15 magnetic disc
16 magnetic fields

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

We claim:

1. A magnetic device for hanging objects from a metal surface, comprising a disc magnet comprising a plurality of poles in a grid pattern and a metal washer adhered to a surface of the disc magnet.

2. The magnetic device of claim 1, wherein the disc magnet is program charged to create alternating charges.

3. The magnetic device of claim 1, comprising nine poles.

4. The magnetic device of claim 3, wherein the nine poles are arranged in a three-by-three grid with approximately 0.75″ between the center of each adjacent pole.

5. The magnetic device of claim 4, wherein the nine poles exert a north polarity and the area between the poles exerts a south polarity.

6. The magnetic device of claim 1, wherein the disc magnet is coated with layers of nickel, copper and epoxy.

7. The magnetic device of claim 1 wherein a combined depth of the disc magnet and metal washer is ⅜″ and a diameter of the disc magnet is 2″.

8. The magnetic device of claim 1, wherein a diameter of the metal washer is the same or larger than a diameter of the disc magnet.
